(19) United States
(12) Patent Application Publication
(10) Pub. No.: US 2007/0091826 A1
(43) Pub. Date: Apr. 26, 2007

(54) Tracing SPVC point-to-multipoint (P2MP) paths

(75) Inventors: Neeraj Chandra, Ottawa (CA); Adel Houssari, Kanata (CA); Benhong Li, Kanata (CA)

Correspondence Address: ECKERT SEAMANS CHERIN & MELLOTT, LLC., US STEEL TOWER, 600 GRANT STREET, 44TH FLOOR, PITTSBURGH, PA, 15219-2788, US

(73) Assignee: Alcatel, Paris (FR)

(21) Appl. No.: 11/255,732

(22) Filed: Oct. 21, 2005

(51) Int. Cl. H04L 12/28

(52) U.S. Cl. 370/255; 370/252

(57) ABSTRACT

A method and system for determining the connections of a communication path are provided. Starting from a one connection point, the identity of the connection point that precedes the one connection point in the direction in which the path was established is requested from the network element on which the one connection point is located. This may be repeated until a root endpoint is reached. Some embodiments are implemented for P2MP SPVC (Soft Permanent Virtual Connection) communications.

### FIELD OF THE INVENTION

The present invention relates to determining connection points of a path of a communication.

### BACKGROUND

In SPVC (Soft Permanent Virtual Connection) communications, calls are established using a network manager. One method of establishing calls in SPVC is called Source-only SPVC. In this case, the network manager instructs a root node to establish calls by specifying the root and destination points but the network manager does not specify the connections to be used. The nodes in the network find the route and establish the necessary connections. Another method is called Dual-endpoint SPVC, in which messages are sent to both the root endpoint and the destination endpoint. The source node is sent a message to connect a call from source endpoint to destination endpoint with all the traffic parameters. Prior to that the destination endpoint is configured with items such as policing, CDVT (Cell Delay Variation Tolerance), spooling, etc.

SPVC is different from a PVC (Permanent Virtual Connection) communications, where the network manager determines each connection along a path for a call and instructs each node to make the connections necessary on the respective node. Therefore, in PVC, the network manager knows each connection in the network, whereas in SPVC, the network manager only has knowledge of the root and destination endpoints of each call.

Point-to-Multipoint (P2MP) calls are available for PVC and SPVC networks and are used to send the same information from one root endpoint to multiple destination endpoints. Each P2MP call of a P2MP group shares the same root endpoint and shares the same connection resources until a point of divergence is reached. After a point of divergence, each call proceeds on a separate path or leaf until a respective leaf endpoint is reached. In a P2MP group, data only flows in one direction, i.e. from the root endpoint to the destination endpoints. One application of P2MP calls is distance learning, where video and sound signals are sent from a lecture to television sets of multiple end users, for example, P2MP is sometimes referred to as multicasting.

Network managers for SPVC communications include a functionality whereby paths for connected calls can be traced and highlighted. The traditional approach used for highlighting P2P (Point to Point) SPVC calls is to start tracing from a source endpoint of the call by querying the node on which the source endpoint is located to determine the other endpoint of the first cross-connect. The other endpoint in the node is connected at a port to a link and the link is connected to and terminates at another endpoint on a second node. The network manager has knowledge of all of the connectivity (links) between nodes and therefore will search its database for the second node and the next endpoint. The second node is queried to obtain the other endpoint of the cross-connect in the second node. This whole process is continued until the remote endpoint of the call is reached, and the network manager has all the path points of the call.

To apply the approach of starting from the source endpoint to P2MP SPVC calls, an extra step is required when a point of divergence is reached. When the network manager queries the node on which the point of divergence is located, asking to where that point is cross-connected, there is more than one answer. Therefore, the node must search its database for the NCCI (Network Call Correlation Identifier) of the specific call in order to determine which connection belongs to the call being traced. There can be more than 500 calls connected from the same root endpoint, with many places across the route or path where certain calls begin to diverge. As a result, the highlight operation can become significantly slower and more costly for P2MP SPVC calls.

The network manager for a SPVC system can interface with the nodes in the system to obtain connection information for ports and connection points on the respective node. In the past, when the network manager requested connection information from a node for a point of divergence on a P2MP call, the connection information for each call or party was provided. For example, all of the VPI/VCI's consumed would be provided.

### SUMMARY OF THE INVENTION

In accordance with one aspect of the present invention, there is provided a method of determining a connection between connection points of a communication path, the method comprising: identifying a first connection point of the communication path on a network element; and requesting, from the network element, the identity of a second connection point connected to the first connection point, wherein the second connection point precedes the first connection point in a direction in which the communication path was established.

Instead of tracing the call from the source (or root) endpoint to the leaf endpoint and running into divergence points, the method and system of the present invention trace calls in a direction opposite to the direction in which the call was connected. For example, in an embodiment, a P2MP SPVC call is traced from the leaf endpoint of the call back to the root endpoint. With this approach, it is never necessary to select one out of many connections because there are no points of divergence, only convergence points.

In another aspect, there is provided a computer readable medium having computer readable instructions stored thereon that when executed by a computer, implement the method of either of the previous aspects.

In another aspect, there is provided a network manager configured to implement the method of either of the previous aspects.

In accordance with a second aspect of the present invention, there is provided a system for determining a connection between connection points of a communication path through a network, the system comprising: an interface adapted to request from a network element the identity of a second connection point connected to an identified first connection point of the communication path, wherein the second connection point precedes the first connection point in a direction in which the communication path was established. Some embodiments of the system also comprise an identifier for identifying the first connection point. Some other embodiments of the system also comprise network information containing connection information for communication paths within the network.

In some embodiments, the communication path is through a switched network. In some embodiments, the communication path is part of a P2MP call. In some embodiments, the connection is a SPVC connection.

In addition, in some embodiments it is possible to query a node for information at a leaf level. The term leaf is used to describe two things: the first is the leaf of a call which refers to the destination endpoint of a call, the second is to describe a leaf of a cross connection.

Other aspects and features of the present invention will become apparent, to those ordinarily skilled in the art, upon review of the following description of the specific embodiments of the invention.

### BRIEF DESCRIPTION OF THE DRAWINGS

Examples of embodiments of the invention will now be described in greater detail with reference to the accompanying drawings, in which:

FIG. 1 is a block diagram of a P2MP communication in a switched network upon which an embodiment of the present invention is implemented;

FIG. 2 is a block diagram of a system according to an embodiment of the present invention;

FIG. 3 is a flowchart of a method of determining the connections of a communication path according to an embodiment of the present invention;

FIG. 4 is a flowchart of a method of determining the connections of a communication path according to an embodiment of the present invention; and

FIG. 5 is a flowchart of a method of determining the connections of a communication path according to an embodiment of the present invention.

### DETAILED DESCRIPTION

Embodiments of the present invention enable the connections of a P2MP call to be determined in a much more efficient manner than the traditional method of starting at the source node for the call. Embodiments of the present invention start to trace the path in a direction opposite to the direction of the call, thereby avoiding points of divergence.

The embodiments described herein are described with reference to SPVC communications, over a switched network, such as an ATM (Asynchronous Transfer Mode) network. However, it is to be understood that the invention can be equally applied to any capable of P2MP calls. Embodiments of the invention are advantageous in networks in which the network manager is not aware of all of the connections of the calls.

In the following description, the term ‘party’ is used to refer to a specific individual call and the term ‘leaf’ is used to refer to a connection point of a cross-connect. A party is identified by its NCCI. A leaf of a cross-connect can have a single call or multiple calls on it.

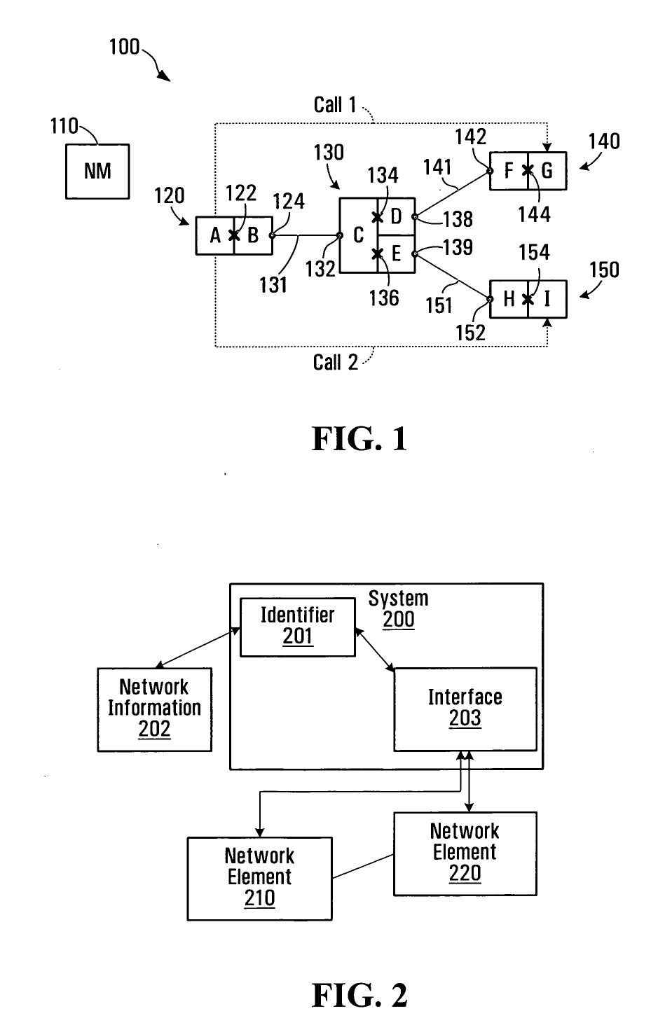

FIG. 1 is a block diagram of a P2MP communication in a switched network 100, upon which an embodiment of the present invention may be implemented. The network 100 comprises four network elements 120, 130, 140 and 150 and a network manager 110. Although not shown, the network manager interfaces with each of the network elements and through those interfaces can obtain connection information for parties and leaves from each of the network elements. Network element 120 is comprised of connection points A and B; network element 130 is comprised of connection points C, D and E; network element 140 is comprised of connection points F and G; and network element 150 is comprised of connection points H and I. Link 131 connects network element 120 to network element 130 at ports 124 and 132, respectively. Link 141 connects network element 130 to network element 140 at ports 138 and 142, respectively. Link 151 connects network element 130 to network element 150 at ports 139 and 152, respectively. An example of a network manager 110 is Alcatel's 5620. Examples of network elements are Alcatel nodes 7670 RSP, 7470, 7270 and 7670 ESE. In some embodiments, the links are cables. In other embodiments, they are wireless connections.

The P2MP group of this embodiment comprises two calls: call 1 and call 2. Call 1 is from connection point A to connection point G and the path is from A to B over cross-connect 122, to C over link 131, to D over cross-connect 134, to F over link 141 and to G over cross-connect 144. Call 2 is from connection point A to connection point I using the path A to B over cross-connect 122, to C over link 131, to E over cross-connect 136, to H over link 151 and to I over cross-connect 154. In an SPVC system, the network manager 110 sets up the P2MP call by sending messages to the source end point network element 120 to establish a call from A to G and a call from A to I. The network elements 120, 130, 140 and 150 find the routes and establish the connections. In embodiments using dual endpoint SPVC, messages are also sent to the destination network elements 140 and 150.

On network element 130, for connection point C (i.e. the root of the connection) there exist two leaves, connection points D and E. In this example each leaf is carrying a single call (i.e. a party). On network element 120 there is a root A and leaf B of the cross-connection. This leaf B is carrying two parties, call 1 and call 2.

In some embodiments, the network manager 110 can display graphical representations of the networks and the calls. In some embodiments, a user can input a command, for example by (double) clicking on a graphical representation of a connection point, and the network manager will interface with the respective network element to obtain the connections associated with that connection point. Embodiments of the present invention enable the network manager to obtain only the information respecting the leaves associated with the connection point, rather than all of the parties connected to that connection point. Other information that the network manager can obtain from the network element includes the circuits associated with a connection point. For example, a network element can provide the node/slot/port/VPI/VCI of a connection point.

It is to be understood that FIG. 1 is a very simple P2MP group and in practice, P2MP groups can be made up of many individual calls. In some cases, 500 to 1000 or more calls are possible. As well, any number of network elements and diversion points can be supported. As the network and the number of calls become more complicated, the advantages of the present invention become more evident.

To determine the connections of call 1 of the embodiment in FIG. 1, the network manager queries network element 140 for the connection information associated with connection point G. Network element 140 will return information advising network manager 110 that connection point G is connected to connection point F over cross-connect 144 and that connection point F is associated with port 142. Connection point F precedes connection point G in the direction in which the communication path was established. Network manager 110 will access its information, which may be stored in a database, to obtain the link associated with port 142 and the port on the next network element to which the link is connected. The network manager will determine that the next port is port 138, which is associated with connection point D. Then, the network manager will query network element 130 for the connection information associated with connection point D. Network element 130 will advise network manager 110 that connection point D is cross-connected to connection point C over cross-connect 134 and that connection point C is associated with port 132. From its information, network manager 110 will know that port 132 is connected to port 124 through link 131. The network manager will then query network element 122 for the connection information associated with connection point B. Network element 120 will advise the network manager that connection point B is cross-connected to connection point A over cross-connect 122. The network manager 110 now has all of the connection information from connection point G to connection point A, which make up call 1. To highlight the path of call 2 a similar process is conducted starting at connection point I.

In some embodiments, the network manager can use the connection information obtained to highlight the path of call 1 or call 2 on a graphical user interface. In some cases, this is in response to a user request to highlight. In other embodiments, the connection information is used to display a graphical list of all the path points of a call.

It can be seen that by starting at connection points G or I, no points of divergence are encountered. Because P2MP calls are from a single point to multiple endpoints and do not converge, when a call is traced in a reverse direction no divergence will ever be encountered.

FIG. 2 is a block diagram of a system 200 configured in accordance with one embodiment of the present invention. The system 200 includes an identifier 201 for identifying a connection point on a communication path from which to start tracing the path. In some embodiments the system identifies the connection point by accessing network information 202. In the embodiment of FIG. 2 the network information 202 is not part of the system 200. In some embodiments, the system 200 includes the network information 202. In some cases, the connection point can be provided by an outside source, such as an operator or a user. Network information 202 may be in the form of a database or any other data structure, as appropriate. Network information 202 may be comprised of information with respect to: calls that are presently connected; all of the network elements of the network; and the connections between the network elements.

In some embodiments the identifier is optional. In those cases, the connection point from which to start the trace is provided by an outside source, such as an operator.

The system also comprises an interface 203. The interface 203 is in communication with the identifier 201 and interfaces with each network element of the network with which system 200 is in communication. In FIG. 2, there are two network elements 210 and 220, which are connected to each other. It is to be understood that system 200 may interface through interface 203 with any number of network elements.

In operation, the identifier 201 identifies a connection point from which to start a trace. The interface 203 interfaces with the network element on which that connection point is located to obtain the preceding connection point on the path. The preceding connection point is preceding in a direction in which the path was established.

In some embodiments, the identifier 201 uses the preceding connection point to obtain a next preceding network element from the network information 202. The interface 203 then obtains the next preceding connection point from the preceding network element. This can continue until the start point of the path is reached.

In some embodiments, the system 200 is a network manager.

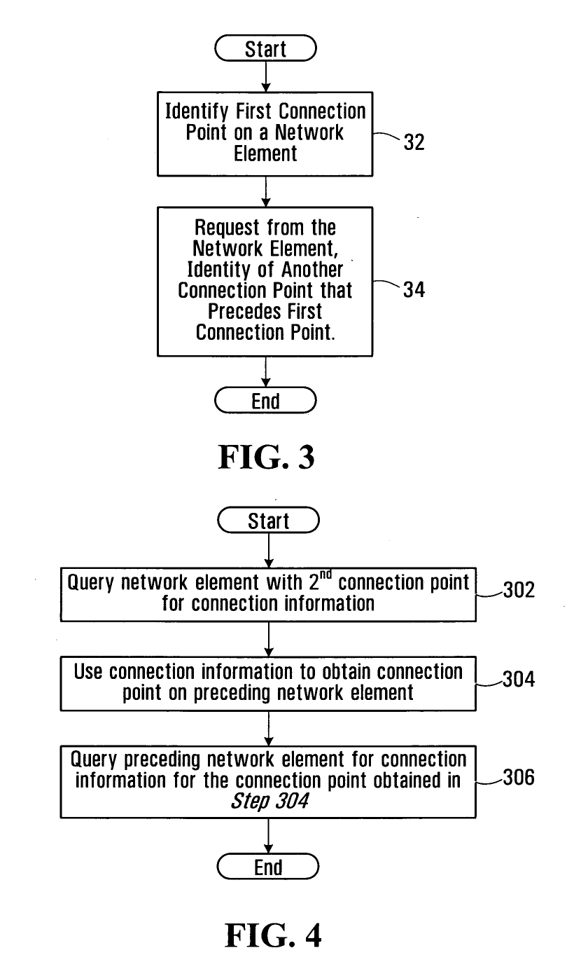

FIG. 3 is a flowchart of a method of determining connection points of a communication path in accordance with one embodiment of the present invention. In step 32, a first connection point is identified on a network element. In some embodiments, this first connection point is a destination connection point of a path to be traced. Then, step 33 comprises requesting, from the network element, the identity of another connection point that precedes the first connection point in the direction in which the path was established.

In some embodiments, the first connection point and the preceding connection point are both located on the same network element.

In some embodiments, the method further comprises identifying another preceding connection point on another network element and obtaining the next preceding connection point to that connection point from the other network element.

In some embodiments, at least one of the connection points is connected to a plurality of connection points in the direction in which the path was established. For example, in a P2MP call, at a point of divergence, a connection point may be connected to many other connection points or leaves.

FIG. 4 is a flow chart of a method in accordance with one embodiment of the present invention. The method is for determining the connections of at least a portion of a communication path where a first and a second connection point are known and the call was connected in a direction from the first to the second connection points. In step 302, a network element, on which the second connection point is located, is queried for connection point preceding the second connection point. The information obtained in step 302 is used to obtain the next preceding connection point on a preceding network element (step 304). In some embodiments, this information is obtained from a database on the network manager. In step 306 the preceding network element is queried for connection point preceding the connection point obtained in step 304.

When this method is applied to a P2MP call, no points of divergence are encountered because the trace starts at a point away from the first connection point and progresses in a direction opposite to that in which the call was connected. Because P2MP calls do not converge in the direction in which the data flows, tracing in the reverse direction avoids points of divergence and the need for network elements to search for specific party identifiers, such as NCCIs. In a preferred embodiment, the trace starts at the destination endpoint of the call and continues to the root endpoint. In some embodiments, the destination endpoint is a logical endpoint.

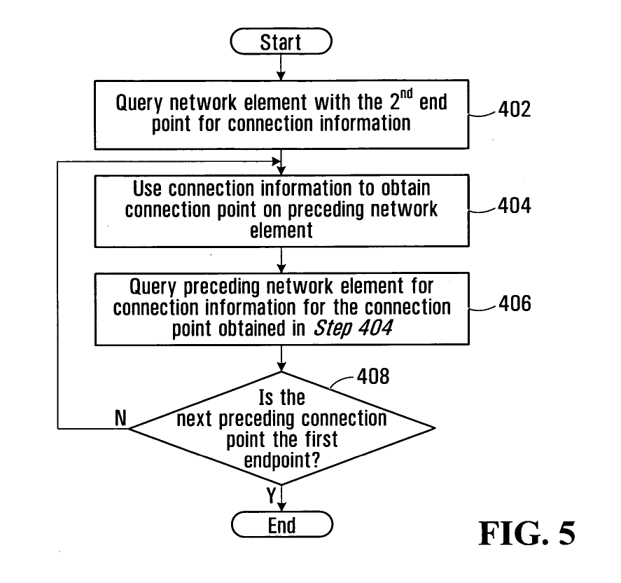

FIG. 5 is a flow chart of a method in accordance with an embodiment of the present invention. Steps 402, 404 and 406 of FIG. 5 are the same as steps 302, 304 and 306 of FIG. 4. New step 408 is a decision in which it is determined whether or not the next preceding connection point is the first endpoint. If the answer is yes, all of the connections of the portion of the path have been obtained and the method ends. If the answer is no, steps 404 and 406 are repeated until the first endpoint is reached.

The methods of embodiments of the present invention are implemented in any combination of software and hardware. Some embodiments comprise a computer readable medium having computer readable instructions stored thereon that when implemented execute the methods of embodiments of the present invention. In some embodiments, of the present invention, a network manager is configured to implement embodiments of the invention.

What has been described is merely illustrative of the application of the principles of the invention. Other arrangements and methods can be implemented by those skilled in the art without departing from the spirit and scope of the present invention.

1. A method of determining a connection between connection points of a communication path, the method comprising:
identifying a first connection point of the communication path on a network element; and
requesting, from the network element, the identity of a second connection point connected to the first connection point,
wherein the second connection point precedes the first connection point in a direction in which the communication path was established.

2. The method of claim 1, wherein the first and second connection points reside on the same network element.

3. The method of claim 1, wherein the second connection point is connected to one or more further connection points, wherein the second connection point precedes the further connection point(s) in the direction in which the path was established.

4. The method of claim 3, wherein the first connection point, the second connection point and the further connection point(s) are all disposed on the same network element.

5. The method of claim 1, further comprising:
identifying a third connection point, on another network element of said communication path, said third connection point being connected to the second connection point, wherein the third connection point precedes the second connection point in the direction in which the path was established; and
requesting from said other network element the identity of a fourth connection point connected to the third connection point,
wherein the fourth connection point precedes the third connection point in the direction in which the path was established.

6. The method of claim 1, wherein the first connection point is a destination endpoint of the communication path.

7. The method of claim 1, further comprising using the identities of the connection points to display the connection path on a user interface.

8. The method of claim 1, wherein the communication path is part of a Point-to-Multipoint (P2MP) communication.

9. The method of claim 9, wherein the communication is a SPVC (Soft Permanent Virtual Connection) communication.

10. A computer readable medium having computer readable instructions stored thereon that when executed by a computer, implement the method of claim 1.

11. The method of claim 1, further comprising displaying the connection points on a user interface.

12. The method of claim 11, wherein the connection points are displayed as a graphical representation of the path.

13. A network manager configured to implement the method of claim 1.

14. A system for determining a connection between connection points of a communication path through a network, the system comprising:
an interface adapted to request from a network element the identity of a second connection point connected to an identified first connection point of the communication path,
wherein the second connection point precedes the first connection point in a direction in which the communication path was established.

15. The system of claim 14, further comprising an identifier for identifying the first connection point.

16. The system of claim 14, further comprising network information containing connection information for communication paths within the network.

17. The system of claim 16, wherein the network information contains the identity of root endpoints and destination endpoints of the communication paths within the network.

18. The system of claim 16, wherein the network information is located in a data base on a network manager.

19. The system of claim 14, wherein the communication path is part of a P2MP (Point-to-Multipoint) communication.

20. The system of claim 19, wherein the communication path was established according to SPVC (Soft Permanent Virtual Circuit) protocol.
